(19) United States
(12) Patent Application Publication
(10) Pub. No.: US 2025/0127092 A1
(43) Pub. Date: Apr. 24, 2025

(54) HAYMAKING MACHINE WITH CONVEYORS AND OPERATING METHOD

(71) Applicant: KUHN SAS, Saverne (FR)

(72) Inventors: Christian GANTZER, Woustviller (FR); Elodie ROTH, Haguenau (FR); Eric ROOS, Niedersoultzbach (FR)

(73) Assignee: KUHN SAS, Saverne (FR)

(21) Appl. No.: 18/919,526

(22) Filed: Oct. 18, 2024

(30) Foreign Application Priority Data
Oct. 23, 2023 (FR) 2311472

(51) Int. Cl. A01D 80/00

(52) U.S. Cl. CPC A01D 80/00

(57) ABSTRACT

Haymaking machine comprising two conveyors, each configured to move a product in a conveying orientation transverse to the direction of advance, in a first or a second conveying direction, and to be driven at a respective speed, with at least one conveyor movable substantially along the conveying orientation, so that the conveyors can be placed in at least one lateral configuration, in which the product is deposited by an outfeed conveyor, and in a central configuration. When the conveyors are placed in the lateral configuration, the speed of at least one of the conveyors is set automatically, so that the speed of the outfeed conveyor is greater than that of the other conveyor(s).

### BACKGROUND OF THE INVENTION

### Field of the Invention

The invention concerns the field of agricultural machinery and relates to an agricultural haymaking machine, and more particularly to a machine equipped with at least two conveyors for transverse movement of a plant product.

The innovation relates more particularly to an agricultural haymaking machine intended to be moved in a direction of advance and comprising at least two conveyors, each configured to move a product in a conveying orientation transverse to the direction of advance, being able to move the product either in a first conveying direction and/or in a second conveying direction, and being drivable at a respective speed, at least one conveyor being movable substantially in the conveying orientation, so that the conveyors can be placed in at least one lateral configuration, in which all the conveyors are adjacent, the conveying directions of all the conveyors are identical, and in which the product is deposited by an outfeed conveyor, with it also being possible to place the conveyors in a central configuration.

### Description of the Related Art

The machine described in the document U.S. Pat. No. 8,833,044A1 corresponds to the above description. However, this machine has a disadvantage when the conveyors occupy the lateral configuration: the outfeed conveyor receives product not only from the associated transfer device, but also from the infeed conveyor. The outfeed conveyor, which is therefore more heavily loaded with product than the infeed conveyor, runs a greater risk of product loss and jamming, which can lead to an irregular windrow, or even to work stoppage, resulting in a loss of time and profitability.

### SUMMARY OF THE INVENTION

The aim of the present innovation is to overcome these problems, and in particular to improve product distribution on the line-mounted conveyors.

To this end, the invention proposes that for an agricultural haymaking machine as mentioned above, when the conveyors are placed in the or each lateral configuration, the speed of at least one conveyor is automatically set so that the speed of the outfeed conveyor is greater than that of the other conveyor(s).

### BRIEF DESCRIPTION OF THE DRAWINGS

The invention will be better understood from the following description, which refers to a preferred embodiment given as a non-limiting example and explained with reference to the attached schematic drawings, in which:

FIG. 1 shows a simplified top view of a haymaking machine according to the preferred embodiment of the invention, with the conveyors in right-hand lateral configuration;

FIG. 2 shows a simplified top view of the machine in FIG. 1, with conveyors in central configuration;

FIG. 3 shows a simplified side view of the machine in FIG. 1, in transport mode;

FIG. 4 shows a simplified top view of a haymaking machine according to a second alternative embodiment of the invention, with the conveyors in left-hand lateral configuration;

FIG. 5 shows a simplified top view of a haymaking machine according to a third alternative embodiment of the invention, hitched to the rear of a tractor, with conveyors in central configuration;

FIG. 6 shows a simplified control diagram of a haymaking machine according to a first alternative embodiment of the invention;

FIG. 7 shows a simplified control diagram of the machine in FIG. 1.

### DETAILED DESCRIPTION OF THE PREFERRED EMBODIMENTS

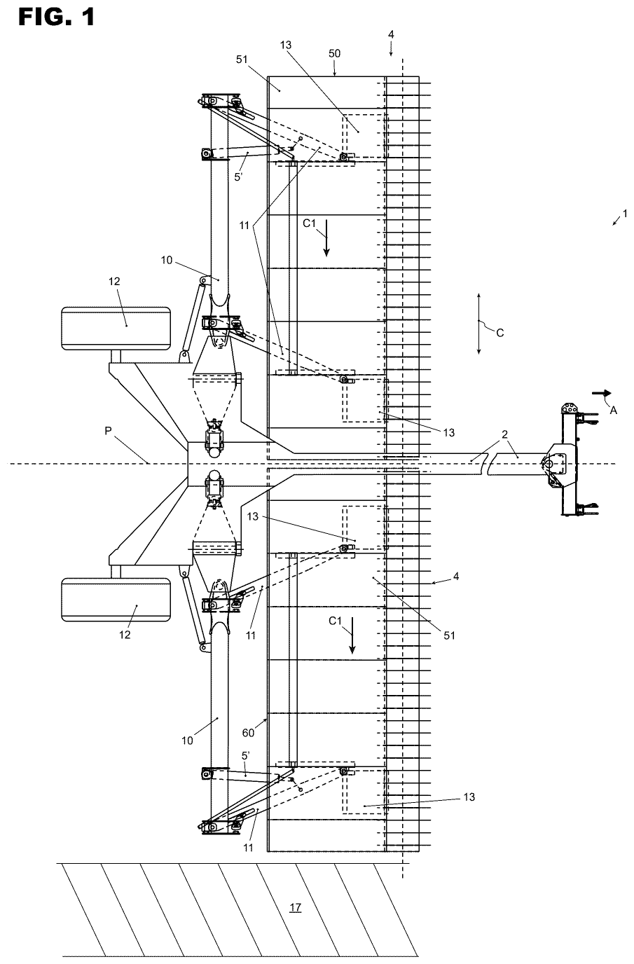

FIG. 1 illustrates an agricultural haymaking machine 1 designed to be moved in a direction of advance A and comprising at least two conveyors 50, 60, 70, 80. The machine 1 also comprises a chassis 2, to which the conveyors 50, 60, 70, 80 are connected. The chassis 2 has a midplane P. Preferably, the chassis 2 and/or machine 1 is/are orthogonally symmetrical with respect to the midplane P.

In the present description, the terms “front”, “rear”, “lateral”, “left”, “right”, “in front” and “behind” are defined when viewed in the direction of advance A. Similarly, the terms “inner” and “outer” are defined in relation to the midplane P. An inner element is closer to the midplane P than an outer element.

Each conveyor 50, 60, 70, 80 is configured to move a product in a conveying orientation C transverse to the direction of advance A. Preferably, the or each conveying orientation C is orthogonal to the direction of advance A. Alternatively, the conveying orientation(s) C of the conveyors 50, 60, 70, 80 can form an angle of up to 30° with the direction of advance A, particularly in a horizontal plane, which also allows transverse movement of the product. The conveying orientations C of the conveyors 50, 60, 70, 80 are preferably parallel. Each conveyor 50, 60, 70, 80 may however have its own conveying orientation C, so that the conveying orientations C of adjacent conveyors 50, 60, 70, 80 form an angle.

In addition, the conveyors 50, 60, 70, 80 are preferably aligned in the conveying orientation C, reducing the length of the machine 1 in the direction of advance A and enabling the product to be moved from one conveyor 50, 60, 70, 80 to another, reducing the risk of product loss. Each conveyor 50, 60, 70, 80 can move the product optionally in a first conveying direction C1 or a second conveying direction C2. Each conveyor 50, 60, 70, 80 can move the product in the first direction C1 or in the second direction C2. The first direction C1 is the opposite of the second direction C2. It is agreed that the first direction C1 is from left to right.

When the product is deposited by a conveyor 50, 60, 70, 80, it forms a windrow 17 on the ground as the machine 1 moves in the direction of advance A. The windrow 17 is therefore longitudinal to the direction of advance A. When a conveyor 50, 60, 70, 80 moves the product in the first direction C1, it can form a windrow 17 to its right.

As shown in FIG. 1 in particular, a transfer device 4 is associated with each conveyor 50, 60, 70, 80. Each transfer device 4 is designed to transfer the product to the associated conveyor 50, 60, 70, 80. Preferably, each transfer device 4 is equivalent in length to the associated conveyor 50, 60, 70, 80 in the conveying orientation C. In particular, each transfer device 4 can be made up of at least one cutterbar and/or at least one pick-up roller. The product can in particular be plant-based, such as grass or straw. When the transfer device 4 includes a cutterbar, it allows mowing standing plants. When the transfer device 4 includes a pick-up roller, it allows moving previously mown plants.

At least one conveyor 50, 60, 70, 80 can be moved substantially in the conveying orientation C. Preferably, all conveyors 50, 60, 70, 80 can be moved substantially in the conveying orientation C. In order to center the windrow 17 on the midplane P, each conveyor 50, 60, 70, 80 can be moved in the conveying orientation C relative to the chassis 2 by a shifting actuator 5. It is agreed that a first conveyor 50 is located on the left-hand side and a second conveyor 60 is located on the right-hand side of the machine 1, seen in the direction of advance A. Preferably, each of the first and second conveyors 50, 60 is located on one side of the chassis 2. By moving at least one conveyor 50, 60, 70, 80 in the conveying orientation C, the conveyors 50, 60, 70, 80 can be placed in at least one lateral configuration, in which all the conveyors 50, 60, 70, 80 are adjacent. Moving at least one conveyor 50, 60, 70, 80 also enables the machine 1 to be adapted to different conditions, in particular to the volume and/or length of the product, but also to the windrow 17 pick-up machine.

In the or each lateral configuration, the conveying directions C1, C2 of all conveyors 50, 60, 70, 80 are identical. In the or each lateral configuration, the product is deposited by an outfeed conveyor 50, 60, 70, 80. The outfeed conveyor 50, 60, 70, 80 is the one closest to the windrow 17. Whatever the lateral configuration, the machine 1 has only one outfeed conveyor 50, 60, 70, 80. In lateral configuration of the conveyors 50, 60, 70, 80, the infeed conveyor 50, 60, 70, 80 is located on the opposite side of the windrow 17. Therefore, in lateral configuration of the conveyors 50, 60, 70, 80, the outfeed conveyor 50, 60, 70, 80 receives product from the infeed conveyor 50, 60, 70, 80.

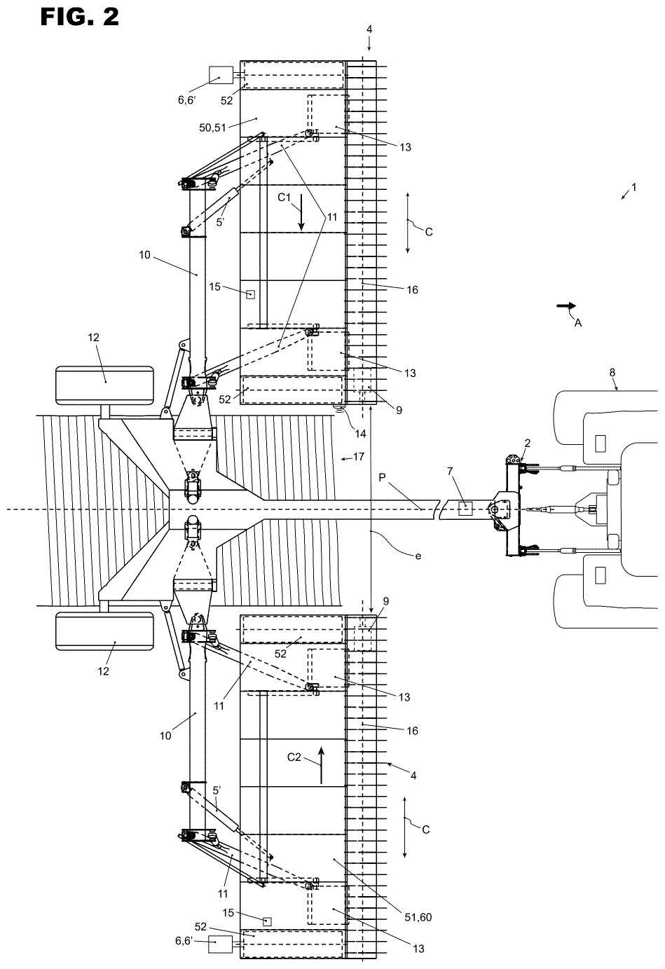

As shown in FIG. 2, the conveyors 50, 60, 70, 80 can also be placed in a central configuration. In the central configuration, the first 50 and second 60 conveyors are further apart from one another than in the or each lateral configuration. The conveyors 50, 60, 70, 80 closest to the midplane P are separated by a central spacing e. In other words, in the central configuration, the conveyors 50, 60, 70, 80 closest to the midplane P are not adjacent.

In the central configuration of the conveyors 50, 60, 70, 80, the conveying directions C1, C2 of the conveyors 50, 60, 70, 80 are directed in the direction of the midplane P. In this way, the product is deposited between the first conveyor 50 and the second conveyor 60. In the central configuration, the direction C1, C2 of the conveyor(s) 50, 60, 70, 80 located on one side of the midplane P is the opposite of the direction C1, C2 of the conveyor(s) 50, 60, 70, 80 located on the other side of the midplane P.

The central spacing e therefore corresponds to the distance between the conveyors 50, 60, 70, 80 between which the windrow 17 is deposited, if applicable. In the embodiments in FIGS. 2, 4 and 6, the central spacing e corresponds to the distance separating the first conveyor 50 from the second conveyor 60. Two conveyors 50, 60, 70, 80 are said to be adjacent when the central spacing e is such that no windrow 17 is formed between them. The central spacing e is measured along the conveying orientation C. In the or each lateral configuration, the central spacing e is substantially zero. When all conveyors 50, 60, 70, 80 are adjacent, there is no space between two adjacent conveyors 50, 60, 70, 80. Preferably, the central spacing e is set by the shifting actuator 5.

The different conveyor configurations 50, 60, 70, 80 enable the machine 1 to be adapted to different working conditions, for example product volume and/or length. The different configurations of the conveyors 50, 60, 70, 80 can also make it possible to adapt the windrow 17, and in particular its width, to the windrow 17 pick-up machine, such as a baler or forage harvester in particular.

As shown in FIG. 2, the machine 1 is preferably hitched to a tractor 8. The tractor 8 allows to move the machine 1 in the direction of advance A. It also makes it possible to drive the machine 1, in particular through its power take-off shaft and its hydraulic circuit. Alternatively, the machine 1 can be self-propelled. The operator of the machine 1 is the driver of the tractor 8 or self-propelled machine. In both cases, each conveyor 50, 60, 70, 80 is preferably connected to the chassis 2 by an arm 10. The midplane P is preferably vertical. The midplane P is also preferably parallel to the direction of advance A.

Preferably, each conveyor 50, 60, 70, 80 comprises a belt 51 and at least two cylinders 52, via which the belt 51 is tensioned. The belt 51 of each conveyor 50, 60, 70, 80 is driven by at least one of the cylinders 52. The at least two cylinders 52 of a belt 51 are driven around axes parallel to the direction of advance A when viewed from above. Since product movement is mainly horizontal, the axes of the cylinders 52 are substantially horizontal. Alternatively, each conveyor 50, 60, 70, 80 can be formed by an auger driven in rotation around a substantially horizontal axis transverse to the direction of advance A.

In order to vary in particular the location and shape of the windrow 17, each conveyor 50, 60, 70, 80 can be driven at a respective speed. In other words, the speed of each conveyor 50, 60, 70, 80 can be set individually. To this end, the speed of each conveyor 50, 60, 70, 80 is preferably set by a power source 6. For belt 51 conveyors 50, 60, 70, 80, the power source 6 is connected to at least one cylinder 52. The power source 6 could be the tractor's 8 power take-off shaft, to which each conveyor 50, 60, 70, 80 would be connected via a controllable respective gearbox and/or inverter. Preferably, each conveyor 50, 60, 70, 80 is associated with a respective power source 6 that can set the speed of this conveyor 50, 60, 70, 80. Preferably, each power source 6 is a hydraulic motor 6′. Preferably, the hydraulic motors 6′ are connected to a hydraulic pump 19. The pump 19 may be part of the machine 1 or the tractor 8. Each power source 6 may also be an electric motor. The conveying direction C1, C2 of a conveyor 50, 60, 70, 80 is determined by the associated power source 6.

As shown in FIGS. 1, 2, 4, and 5, the machine 1 is in work mode. We refer to the different conveyor 50, 60, 70, 80 configurations, especially when the machine 1 is in work mode. As can be seen from the figures, each transfer device 4 extends preferably substantially parallel to the associated conveyor 50, 60, 70, 80. Each transfer device 4 is preferably rigidly fastened to the associated conveyor 50, 60, 70, 80, so that when a conveyor 50, 60, 70, 80 occupies a given configuration, the associated transfer device 4 occupies the same configuration. In the work mode of the machine 1, each transfer device 4 is located in front of the associated conveyor 50, 60, 70, 80, thus facilitating the transfer of the product in the opposite direction to the direction of advance A.

In work mode, the transfer devices 4 harvest the product from the ground and the conveyors 50, 60, 70, 80 extend substantially horizontally and/or parallel to the ground. To enable the transfer devices 4 and/or conveyors 50, 60, 70, 80 to follow the unevenness of the ground when moving the machine 1, each arm 10 can pivot relative to the chassis 2 along at least one axis oriented parallel to the midplane P.

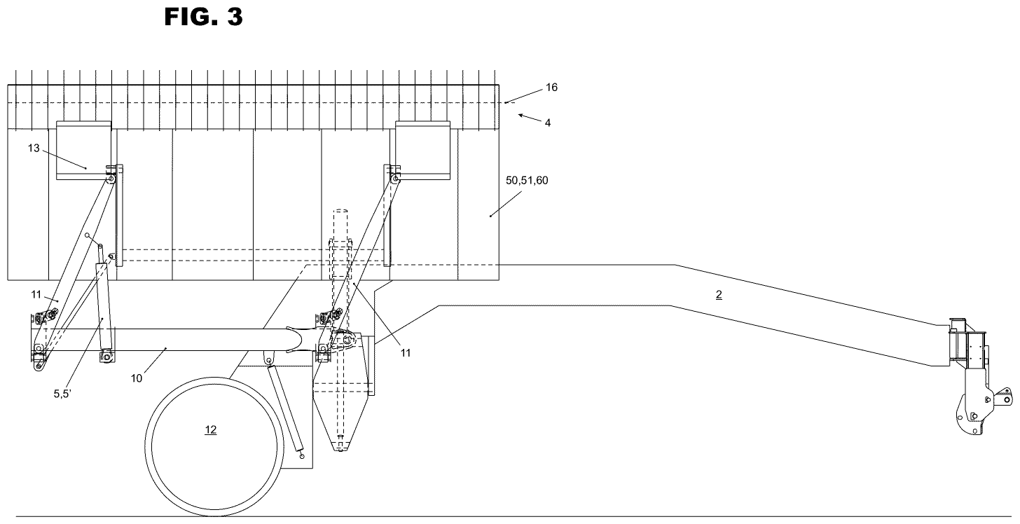

As can be seen in FIG. 3, the machine 1 can occupy a transport mode in which the conveyors 50, 60, 70, 80 are oriented at least substantially parallel to the midplane P, thus reducing the width of the machine 1. To reduce the height of the machine 1 in the transport configuration, the conveyors 50, 60, 70, 80 are preferably oriented parallel to the direction of advance A. Furthermore, in the transport configuration, the conveyors 50, 60, 70, 80 are located at a certain distance from the ground to allow a higher speed of advance on the road without damaging the machine 1. It can be seen from the above that the machine 1 can occupy at least one other mode.

Preferably, the machine 1 can also occupy a headland mode in which the conveyors 50, 60, 70, 80 are slightly raised from the ground. In the headland mode of the machine 1, the conveyors 50, 60, 70, 80 are oriented transversely to the direction of advance A. The headland mode is an intermediate position of the conveyors 50, 60, 70, 80 between the work and transport modes, allowing to prevent the conveyors 50, 60, 70, 80 from interfering with the product on the ground. Switching to headland mode takes less time than switching to transport mode.

According to one important feature, when the conveyors 50, 60, 70, 80 are placed in the or each lateral configuration, the speed of at least one of the conveyors 50, 60, 70, 80 is automatically set so that the speed of the outfeed conveyor 50, 60, 70, 80 is greater than that of the other conveyor(s) 50, 60, 70, 80.

As a result of these arrangements, in lateral configuration, the speed of each conveyor 50, 60, 70, 80 is automatically adapted to the volume and/or quantity of product it has to move in relation to the other conveyors 50, 60, 70, 80, thus allowing an even product distribution on all conveyors 50, 60, 70, 80 and advantageously reducing the risk of jamming on the machine 1. The speed of advance of the machine 1 can thus be increased to speed up the farm work, while reducing the risk of product loss, irregular windrows 17 and stoppage of the machine 1. In addition, the fact that the speed of the conveyors 50, 60, 70, 80 is set automatically makes for greater driving comfort, as the user has one less parameter to set, thereby reducing the risk of errors or oversights.

Preferably, when the conveyors 50, 60, 70, 80 are placed in the or each lateral configuration, the speed of the outfeed conveyor 50, 60, 70, 80 is automatically increased, for example by a speed 0% to 50% greater than that of the infeed conveyor 50, 60, 70, 80. Alternatively or additionally, the speed of the infeed conveyor 50, 60, 70, 80 can be reduced. In a simple manner, when the conveyors 50, 60, 70, 80 are placed in the or each lateral configuration, only the speed of the outfeed conveyor 50, 60, 70, 80 is increased.

Furthermore, when the conveyors 50, 60, 70, 80 are placed in the or each lateral configuration, the conveying direction C1, C2 of at least one of the conveyors 50, 60, 70, 80 is automatically set so that the conveying directions C1, C2 of all the conveyors 50, 60, 70, 80 are identical. Preferably, when the conveyors 50, 60, 70, 80 are placed in a lateral configuration, the conveying directions C1, C2 of each conveyor 50, 60, 70, 80 are automatically set so that they are identical. As a result, the user does not have to set the conveying direction C1, C2 of any of the conveyors 50, 60, 70, 80 (when the conveyors 50, 60, 70, 80 are placed in a lateral configuration), thus reducing the risk of operating errors and/or oversights, and improving the driving comfort of the machine 1. This furthermore saves the user setup time, also enabling to speed up farm work.

In the preferred embodiment in FIG. 1, the machine 1 has only two conveyors 50, 60, 70, 80, namely the first conveyor 50 and the second conveyor 60. In FIG. 1, the first conveyor 50 and the second conveyor 60 are adjacent and directed in the first conveying direction C1, so that they occupy a right-hand lateral configuration. The product is thus deposited in a windrow 17 located to the right of the outfeed conveyor 50, 60, 70, 80, respectively to the right of the machine 1. In FIG. 1, the outfeed conveyor 50, 60, 70, 80 is the second conveyor 60. In FIG. 1, the infeed conveyor 50, 60, 70, 80 is the first conveyor 50. Preferably, the conveyors 50, 60, 70, 80 can also be placed in a left-hand lateral configuration, in which they are adjacent and move the product in the second conveying direction C2.

Therefore, when the conveyors 50, 60, 70, 80 are placed in the right-hand lateral configuration, the conveying direction C1, C2 of all conveyors 50, 60, 70, 80 is automatically set to the first direction C1. Symmetrically, when the conveyors 50, 60, 70, 80 are placed in the left-hand lateral configuration, the conveying direction C1, C2 of all conveyors 50, 60, 70, 80 is automatically set to the second direction C2. As a result, whatever the lateral configuration selected, the user does not have to set the conveying direction C1, C2 (when the conveyors 50, 60, 70, 80 are placed in this lateral configuration), thus reducing the risk of operating errors and/or oversights, and improving its driving comfort. The user also saves setup time, also enabling to speed up farm work and allowing him to concentrate on other tasks, such as steering the tractor 8.

According to one feature of interest, when the conveyors 50, 60, 70, 80 are placed in the central configuration, at least the speeds of the conveyors 50, 60, 70, 80 closest to the midplane P are set automatically to an identical value lower than the speed of the outfeed conveyor 50, 60 in the lateral configuration, enabling a regular and centered windrow to be obtained. In this way, at least the speeds of the first conveyor 50 and the second conveyor 60 are automatically set to an identical value. In fact, in this central configuration, two conveyors 50, 60, 70, 80 deposit product between them, so that an excessively high speed of at least one of these conveyors 50, 60, 70, 80 may involve a scattering and/or random interweaving of the product coming from each conveyor 50, 60, 70, 80, and therefore presents a greater risk of forming an uneven windrow 17. Preferably, when the conveyors 50, 60, 70, 80 are placed in the central configuration, the speeds of all the conveyors 50, 60, 70, 80 are automatically set to an identical value.

In addition, when the conveyors 50, 60, 70, 80 are placed in the central configuration, at least the speeds of the first conveyor 50 and the second conveyor 60 are automatically set to a value lower than the speed of the outfeed conveyor 50, 60, 70, 80 in lateral configuration, advantageously reducing the power consumption of the machine 1 in central configuration. Reducing the speed of the conveyors 50, 60, 70, 80 in the central configuration also makes it possible to form more consistent windrows 17, as the impact of the two product flows is reduced. Preferably, when the conveyors 50, 60, 70, 80 are placed in the central configuration, the speeds of all the conveyors 50, 60, 70, 80 are automatically set to a value lower than the speed of the outfeed conveyor 50, 60, 70, 80 in lateral configuration

In the preferred embodiment, when the first 50 and second 60 conveyors are placed in the central configuration, their speeds are automatically set to a value identical to and lower than the speed of any of the conveyors 50, 60, 70, 80 in lateral configuration, further reducing the power consumption of the machine 1 in central configuration and contributing to an even more consistent windrow 17.

Preferably, when the conveyors 50, 60, 70, 80 are placed from the central configuration into the or each lateral configuration, the speed of the outfeed conveyor 50, 60, 70, 80 is automatically increased, for example to a speed 0% to 50% greater than its speed in central configuration.

In addition, when the conveyors 50, 60, 70, 80 are placed in the central configuration, the conveying direction C1, C2 of at least one of the conveyors 50, 60, 70, 80 is automatically set so that the conveying direction C1, C2 of each of these conveyors 50, 60, 70, 80 is directed in the direction of the midplane P. Preferably, when the conveyors 50, 60, 70, 80 are placed in a lateral configuration, the conveying direction C1, C2 of each conveyor 50, 60, 70, 80 is automatically set so that it is directed in the direction of the midplane P. Therefore, the user does not have to set the conveying direction C1, C2 of any of these conveyors 50, 60, 70, 80 (when the conveyors 50, 60, 70, 80 are placed in the central configuration), thus avoiding any operating errors and/or oversights, and improving the driving comfort of the machine 1. Such a feature also enables saving setup time, speeding up farm work and allowing the user to concentrate on the other tasks such as driving the tractor.

Preferably, the machine 1 comprises a monitoring device 7. The monitoring device 7 is able to send a signal to control one or more parameters of the machine 1. In particular, the monitoring device 7 can set the speed of at least one conveyor 50, 60, 70, 80. Similarly, the monitoring device 7 can in particular set the conveying direction C1, C2 of at least one conveyor 50, 60, 70, 80. The monitoring device 7 is able to send a signal enabling to set the speed of each of the conveyors 50, 60, 70, 80. The monitoring device 7 is also able to send a signal enabling to set the conveying direction C1, C2 of each of the conveyors 50, 60, 70, 80. In this way, the user can control the machine 1 by entering instructions on the monitoring device 7 or on a terminal sending these instructions to the monitoring device 7, facilitating use and improving the ergonomics of the machine 1. The terminal and monitoring device 7 can form a single component. To be practical, the monitoring device 7 is advantageously located in the driver's cab of the self-propelled machine 1 or the tractor 8.

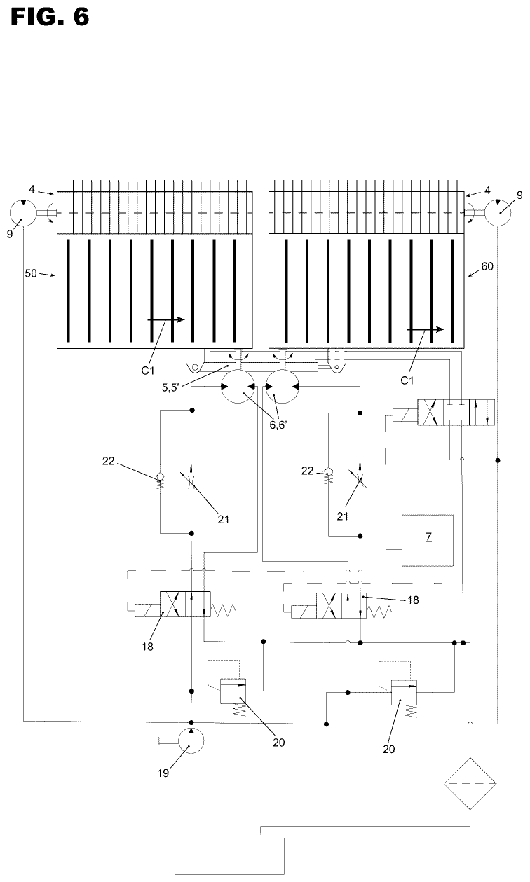

As shown in FIG. 6, with at least one conveyor 50, 60, 70, 80 is associated a hydraulic control valve 18. Depending on its position, the or each hydraulic control valve 18 allows to connect the respective hydraulic motor 6′ to a hydraulic pump 19 to drive the associated conveyor 50, 60, 70, 80 so that it moves the product in the first or second conveying direction C1, C2. Preferably, a hydraulic control valve 18 is associated with each conveyor 50, 60, 70, 80. In a first alternative embodiment shown in FIG. 6, the machine 1 comprises only two conveyors 50, 60, 70, 80, with each of which is associated a pressure control valve 20 and a flow limiter 21, to the terminals of which a non-return valve 22 is connected.

As shown in FIG. 6, the positions of the hydraulic control valves 18 correspond to a right-hand lateral configuration of the conveyors 50, 60, 70, 80, as well as to a speed of the first conveyor 50 that is lower than the speed of the second conveyor 60. In fact, the hydraulic control valve 18 associated with the first conveyor 50 directs the oil coming from one or the pump 19 through the associated flow limiter 21, while the hydraulic control valve 18 associated with the second conveyor 60 directs the oil in an unrestricted pipe, so that the speed of the first conveyor 50 is lower than the speed of the second conveyor 60. Furthermore, as shown in FIG. 6, each hydraulic control valve 18 directs the oil to the associated hydraulic motor 6′, so that each of the first and second conveyors 50, 60 has the same conveying direction, i.e. the first conveying direction C1.

As shown in FIG. 6, the monitoring device 7 can change the position of one or each hydraulic control valve 18. The monitoring device 7 can also control the shifting actuator 5. The monitoring device 7 can therefore be configured so that, when the user enters an instruction (via the monitoring device 7) to switch to a lateral configuration, the monitoring device 7 sends, preferably simultaneously, a signal to the shifting actuator 5, so that the first and second conveyors 50, 60 are made adjacent, and a signal to the hydraulic control valves 18, so that the first and second conveyors 50, 60 have identical directions C and different speeds. One advantage of this first alternative embodiment is that the signal sent by the monitoring device 7 can be electric or hydraulic. In this way, the invention can advantageously be applied even if the tractor 8 has no electronics.

In the first alternative embodiment, the monitoring device 7 can be configured so that, when the user enters an instruction (via the monitoring device 7) to switch to a central configuration, the monitoring device 7 sends:
a signal to the shifting actuator 5 to separate the first and second conveyors 50, 60 by a central spacing e;
a signal to position the hydraulic control valve 18 associated with the second conveyor 60 so that the oil is directed through the associated flow limiter 21 and the associated hydraulic motor 6′ drives the second conveyor 60, so that it moves the product in the second conveying direction C2, and
a signal to the hydraulic control valve 18 associated with the first conveyor 50, so that the oil is directed through the associated flow limiter 21 and the associated hydraulic motor 6′ drives the second conveyor 60, so that it moves the product in the first conveying direction C1. As a result, the first and second conveyors 50, 60 are separated from one another, move the product in opposite conveying directions C1, C2 and have identical and lower speeds than the outfeed conveyor 50, 60, 70, 80 in lateral configuration. It can be seen from the above that in the first alternative embodiment, the monitoring device 7 is configured to automatically set the central spacing e, as well as the conveying directions C1, C2 and speeds of the conveyors 50, 60, 70, 80, based on their configuration.

In a fourth alternative embodiment, the monitoring device 7 is configured so that each configuration of the conveyors 50, 60, 70, 80 is associated with a respective command. In particular, the monitoring device 7 can be configured to have a first command making it possible to place the conveyors 50, 60, 70, 80 in the right-hand lateral configuration and a second command making it possible to place the conveyors 50, 60, 70, 80 in the central configuration, so that one command automatically makes it possible to position the conveyors 50, 60, 70, 80. Preferably, the monitoring device 7 can also have a third command making it possible to place the conveyors 50, 60, 70, 80 in their left-hand lateral configuration. Therefore, in the fourth alternative embodiment, a first command from the monitoring device 7 automatically makes it possible to set the central spacing e, the conveying directions C1, C2 and the speeds of the conveyors 50, 60, 70, 80 in order to place the conveyors 50, 60, 70, 80 in the right-hand lateral configuration. Therefore, in the fourth alternative embodiment, a second command from the monitoring device 7 automatically makes it possible to set the central spacing e, the conveying directions C1, C2 and the speeds of the conveyors 50, 60, 70, 80 in order to place the conveyors 50, 60, 70, 80 in the central configuration. Lastly, in the fourth alternative embodiment, a third command from the monitoring device 7 automatically makes it possible to set the central spacing e, the conveying directions C1, C2 and the speeds of the conveyors 50, 60, 70, 80 in order to place the conveyors 50, 60, 70, 80 in the left-hand lateral configuration. Preferably, each of the first, second and third commands is activated by a respective button on the terminal, or the monitoring device 7 respectively, making it particularly easy to change the configuration of the conveyors 50, 60, 70, 80.

It is emphasized that in the alternative embodiment shown in FIG. 6, each pressure control valve 20 allows excess oil to be discharged when directed to the associated flow limiter 21. One disadvantage of this alternative embodiment is that the use of a pressure control valve 20 increases the power consumption of the or each pump 19 and can cause the oil to heat up, which can reduce its quality.

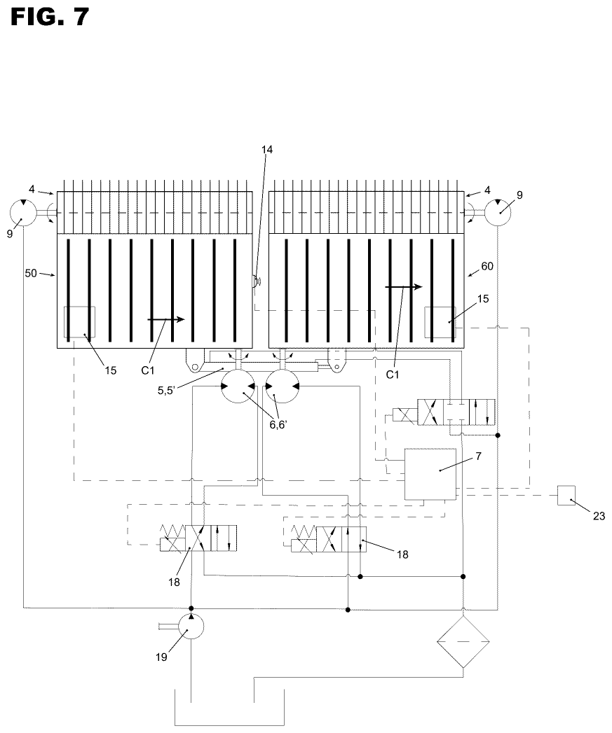

As shown in FIG. 7, the monitoring device 7 is preferably an electronic control unit ECU. The monitoring device 7 is thus able to receive a signal representing the configuration of the conveyors 50, 60, 70, 80. The signal representing the configuration of the conveyors 50, 60, 70, 80 may in particular comprise a signal representing the conveying direction C1, C2 of each conveyor 50, 60, 70, 80 and a signal representing the central spacing e. Alternatively or additionally, the signal representing the configuration of the conveyors 50, 60, 70, 80 may comprise a signal representing the speed of each conveyor 50, 60, 70, 80, and/or a signal representing comparisons of these speeds. In practice, the signals received and sent by the monitoring device 7 comply with the ISOBUS standard (ISO 11783).

The machine 1 can include a distance sensor 14 able to send to the monitoring device 7 a signal representing the central spacing e. The signal representing the central spacing e can be sent by the distance sensor 14, when the conveyors 50, 60, 70, 80 concerned are adjacent and/or when the central spacing e exceeds a limit value. The limit value for the central spacing e can be 0 (zero) meters. The distance sensor 14 could be integrated into the shifting actuator 5.

In order to be able to vary the width of the windrow 17, the monitoring device 7 can preferably adjust the central spacing e continuously, for example between 0 and 4 meters. As shown in FIG. 7, to each hydraulic motor 6′ can be connected a proportional hydraulic control valve 18. According to the preferred embodiment, the distance sensor 14 makes it possible to measure the central spacing e between the first and second conveyors 50, 60 and sends to the monitoring device 7 a signal proportional to the central spacing e. Alternatively or additionally, the speed of at least one conveyor 50, 60, 70, 80 can be set in proportion to the central spacing e in central configuration. For example, the speeds of the first and second conveyors 50, 60 can be set so that the greater the central spacing e, the greater the speeds of the first and second conveyors 50, 60, thus reducing the risk of jamming.

The machine 1 can comprise a direction sensor 15 associated with each conveyor 50, 60, 70, 80 and able to send to the monitoring device 7 a signal representing the conveying direction C1, C2 of each conveyor 50, 60, 70, 80. Preferably, each direction sensor 15 is integrated into the power source 6 associated with the respective conveyor 50, 60, 70, 80.

Preferably, the monitoring device 7 is able to send to each hydraulic control valve 18 a signal representing the required conveying direction C1, C2, proportional to the desired speed for the associated conveyor 50, 60, 70, 80, thereby allowing simple, economical and easily modifiable automation of the continuous speed adjustment of the conveyors 50, 60, 70, 80.

Preferably, the monitoring device 7 can adjust the conveying direction C1, C2 and the speed of at least one conveyor 50, 60, 70, 80 based on the signal representing the configuration of the conveyors 50, 60, 70, 80. Alternatively or additionally, the monitoring device 7 can set the conveying direction C1, C2 and the speed of each conveyor 50, 60, 70, 80 based on the signal representing the configuration of the conveyors 50, 60, 70, 80, respectively based on the configuration of the conveyors 50, 60, 70, 80.

According to another feature of interest, the speed of each conveyor 50, 60, 70, 80 is automatically set in proportion to the speed of advance of the machine 1, enabling the speed of the conveyors 50, 60, 70, 80 to be matched to the product flow. In fact, the higher the speed of advance of the machine 1, the greater the product flow, and the faster the conveyors 50, 60, 70, 80 have to move the product to avoid jamming. Therefore, whatever the configuration of the conveyors 50, 60, 70, 80, the speed of a conveyor 50, 60, 70, 80 is proportional to the speed of advance of the machine 1. This automation further enhances driving comfort.

According to an advantageous feature, the monitoring device 7 can comprise a storage device. When the monitoring device 7 receives the signal representing the speed of advance of the machine 1, it can compare this speed with one or more values stored in its storage device and set the speed of each conveyor 50, 60, 70, 80 based on this (these) comparison(s). In particular, the speed of each conveyor 50, 60, 70, 80 could be set based on different levels in the speed of advance.

The monitoring device 7 can receive a signal representing the speed of advance of the machine 1. The signal representing the speed of advance of the machine 1 can be obtained by at least one of a GPS sensor 23, a speed sensor mounted on the machine 1 and/or a speed sensor integrated into the tractor 8.

It can be seen that the monitoring device 7 is able to receive a signal representing the speed of advance of the machine 1 and that the monitoring device 7 is able to set the speed of at least one conveyor 50, 60, 70, 80 based on this speed of advance. Preferably, the monitoring device 7 is able to receive a signal representing the speed of advance of the machine 1 and set the speed of each conveyor 50, 60, 70, 80 based on this speed of advance.

Preferably, the ratio of the speed of each conveyor 50, 60, 70, 80 to the speed of advance of the machine 1 can be set, allowing greater adaptability to different product conditions and/or user preferences. In order to ensure movement of the product even when the speed of advance of the machine 1 is zero or low, the monitoring device 7 can be configured to set the speed of each conveyor 50, 60, 70, 80 to a minimum value when the speed of advance of the machine 1 is below a given limit. Preferably, when the speed of advance of the machine 1 is below a given limit, the monitoring device 7 is configured to set the speed of each conveyor 50, 60, 70, 80 to a value equal to thirty percent (30%) of its maximum speed. This limit determined for the speed of advance of the machine 1 may, for example, be 5 km/h. Alternatively or additionally, the user can set a minimum value for the speed of each conveyor 50, 60, 70, 80 and/or a minimum ratio between the speed of each conveyor 50, 60, 70, 80 and the speed of advance of the machine 1. The minimum value of the speed of each conveyor 50, 60, 70, 80 can depend on the ratio between the speed of each conveyor 50, 60, 70, 80 and the speed of advance of the machine 1. Therefore, even if the machine 1 is moving at a low speed, the speed of each conveyor 50, 60, 70, 80 remains greater than this minimum value.

In order to prevent the product from being ejected too far by each or by the conveyor 50, 60, 70, 80, the user can also set a maximum value for the speed of each conveyor 50, 60, 70, 80 and/or a maximum ratio between the speed of each conveyor 50, 60, 70, 80 and the speed of advance of the machine 1. Therefore, even if the machine 1 is moving at a high speed, the speed of each conveyor 50, 60, 70, 80 remains lower than this maximum value.

Preferably, each transfer device 4 is a pick-up roller driven in rotation around a respective roller axis 16. Preferably, each roller axis 16 is parallel to the conveying orientation. Each pick-up roller has fingers distributed around its periphery and intended to pick up the product from the ground and transfer it to the associated conveyor 50, 60, 70, 80 by throwing it backwards. Each pick-up roller is preferably driven around the respective roller axis 16 by a respective drive motor 9. The drive motor 9 can in particular be hydraulic or electric. Each pick-up roller could however also be driven via the tractor's 8 power take-off shaft.

Preferably, each transfer device 4 can have a respective transfer speed. According to one feature of interest, the monitoring device 7 can be configured to automatically set the speed of each transfer device 4 based on the speed of the associated conveyor 50, 60, 70, 80. This feature enables greater driving comfort, as the user has one less parameter to set each time the configuration of the conveyors 50, 60, 70, 80 is changed, thus reducing the risk of operating errors and/or oversights. This also saves the user setup time, which in turn enables to speed up farm work. Adapting the speed of the transfer devices 4 to the speed of advance of the machine 1 also enables their speed to be adapted to the product flow to be transferred. In particular, the monitoring device 7 can be configured to set the speed of each transfer device 4 in proportion to the speed of the associated conveyor 50, 60, 70, 80.

In the preferred embodiment in FIGS. 1 and 2, the machine 1 has no conveyors 50, 60, 70, 80 other than the first conveyor 50 and the second conveyor 60. In the preferred embodiment, the machine 1 has no central conveyors 70, 80.

Alternatively, the machine 1 can have at least one central conveyor 70, 80. The or each central conveyor 70, 80 is located between the first and second conveyors 50, 60 in the work mode of the machine 1. Therefore, when the conveyors 50, 60, 70, 80 are placed in the or each lateral configuration, the monitoring device 7 is configured to automatically set the speed of each conveyor 50, 60, 70, 80, so that the closer the conveyor 50, 60, 70, 80 is to the outfeed conveyor 50, 60, 70, 80, the greater its speed, thus making it possible to prevent jamming on a machine 1 with more than two conveyors 50, 60, 70, 80. In fact, the more conveyors 50, 60, 70, 80 the machine 1 has, the greater the risk of jamming, particularly on the outfeed conveyor 50, 60, 70, 80.

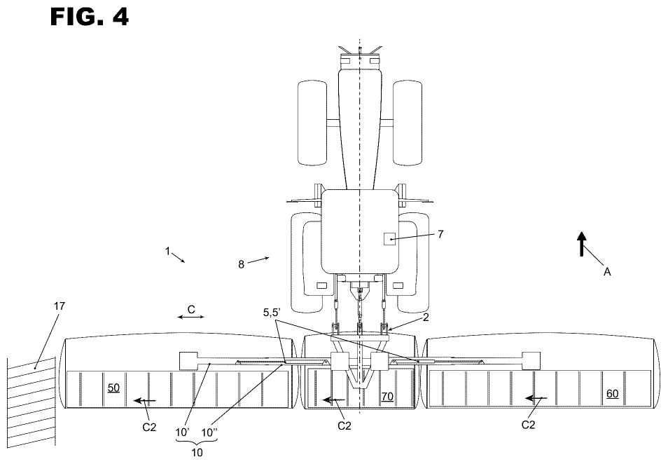

In a second alternative embodiment shown in FIG. 4, the machine 1 has a single central conveyor 70. In this second alternative embodiment, the central conveyor 70 is located between the first conveyor 50 and the second conveyor 60 in work mode. According to this second alternative embodiment, in the central configuration, to allow the windrow 17 to be deposited between the first and second conveyors 50, 60, the central conveyor 70 is retracted. According to this alternative embodiment, in the central configuration, the central conveyor 70 can in particular be moved into the position it occupies when the machine 1 is in headland mode. Alternatively, in central configuration, the central conveyor 70 is completely removed from the machine 1. According to the second alternative embodiment, only the infeed and outfeed conveyors 50, 60, 70, 80 can be moved relative to the chassis 2 in the conveying orientation C. As shown in FIG. 4, in the left-hand lateral configuration, the outfeed conveyor 50, 60, 70, 80 is the first conveyor 50 and the infeed conveyor 50, 60, 70, 80 is the second conveyor 60.

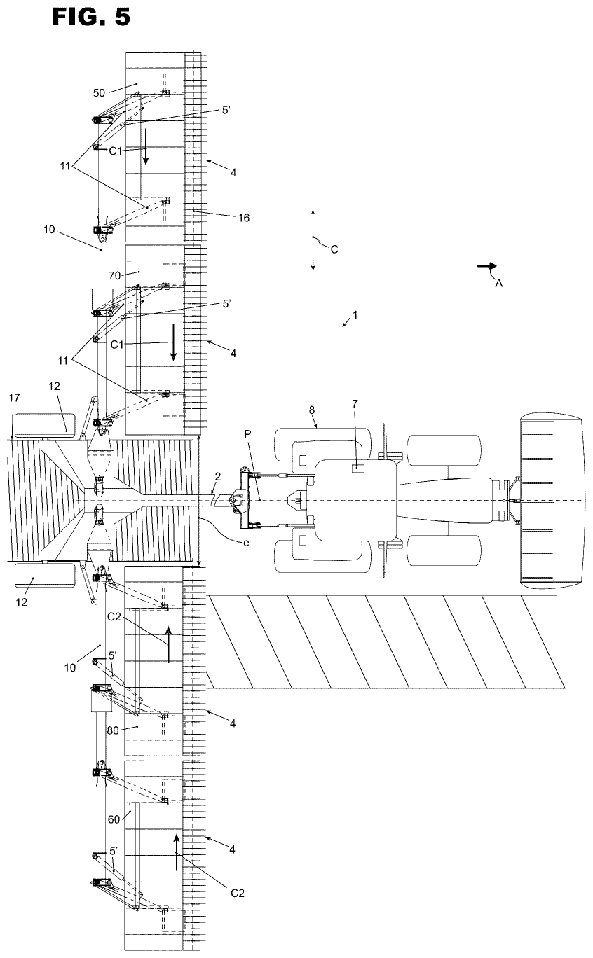

According to a third alternative embodiment shown in FIG. 5, the machine 1 comprises a first central conveyor 70 and a second central conveyor 80. In this alternative embodiment, each central conveyor 70, 80 is located between the first conveyor 50 and the second conveyor 60 in the work mode of the machine 1. It is agreed that the first central conveyor 70 is located between the first conveyor 50 and the second central conveyor 80 in the conveying orientation C and in the work mode of the machine 1. At least according to the third alternative embodiment, in the central configuration, the conveying directions C1, C2 of the conveyors 50, 60, 70, 80 located on the same side of the midplane P are identical. Furthermore, according to this third alternative embodiment, in the central configuration, the conveying direction C1, C2 of the conveyors 50, 60, 70, 80 located on one side of the midplane P is the opposite of the conveying direction C1, C2 of the conveyors 50, 60, 70, 80 located on the other side of the midplane P.

In the central configuration, the first and second conveyors 50, 60 are offset from their position in lateral configuration. According to the third alternative embodiment, the central conveyors 70, 80 can also be moved substantially in the conveying orientation C. According to the third alternative embodiment, in the central configuration, each conveyor 50, 60, 70, 80 is moved away from the midplane P in the conveying orientation C relative to its position in lateral configuration. According to the third alternative embodiment, the distance sensor 14 makes it possible to measure the central spacing e between the central conveyors 70, 80. According to this third alternative embodiment, in the central configuration, the first conveyor 50 is adjacent to the first central conveyor 70 and the second conveyor 60 is adjacent to the second central conveyor 80, in order to form a single windrow 17 between the central conveyors 70, 80. Finally, according to the third alternative embodiment, in the central configuration of the conveyors 50, 60, 70, 80, the conveying directions C1, C2 of the conveyors 50, 60, 70, 80 are such that the product is deposited between the central conveyors 70, 80.

Each change of configuration of the conveyors 50, 60, 70, 80 is carried out by the shifting actuator 5. With each conveyor 50, 60, 70, 80 can be associated at least one respective hydraulic cylinder 5′. In the preferred embodiment, the shifting actuator 5 is formed by two hydraulic cylinders 5′. The shifting actuator 5 could however be a single hydraulic cylinder 5′ connected to the first conveyor 50 and to the second conveyor 60.

As shown in FIG. 4, each arm 10 can comprise a first part 10′ of the arm 10 connected to the respective conveyor 50, 60, 70, 80 and a second part 10″ connected to the chassis 2. The first part 10′ can slide in relation to the second part 10″, for example by means of a respective hydraulic cylinder 5′. Each arm 10 is then preferably telescopic.

Preferably, each of the conveyors 50, 60, 70, 80 is connected to the respective arm 10 by two offset rods 11. Each offset rod 11 is advantageously connected to a respective conveyor 50, 60, 70, 80 and to the arm 10 by a respective joint allowing pivoting around at least one substantially vertical axis. In this way, the arm 10, each conveyor 50, 60, 70, 80 and the two respective offset rods 11 form a four-bar mechanism in a horizontal plane, allowing each conveyor 50, 60, 70, 80 to move in the conveying orientation C relative to the chassis 2. Thanks to this four-bar mechanism, each conveyor 50, 60, 70, 80 can be moved mainly in the conveying orientation C, but also slightly in the direction of advance A. The use of offset rods 11 and a four-bar mechanism in particular makes it possible to reduce the effort required to move the conveyors 50, 60, 70, 80 and improves the repairability of the machine 1. In addition, the same offset rods 11 can also make it possible to guide the vertical movement of the conveyors 50, 60, 70, 80. To this end, each joint between an offset rod 11 and the respective arm 10, as well as each joint between an offset rod 11 and the respective conveyor 50, 60, 70, 80, also allows pivoting around at least one substantially horizontal axis, advantageously enabling the conveyors to be placed in a maneuvering and/or transport configuration. In addition, by allowing each conveyor 50, 60, 70, 80 to pivot in a vertical plane in the or each lateral and central configuration, the offset rods 11 enable dynamic tracking of uneven ground, improving the work quality while reducing damage to the plant cover on the ground.

As shown in FIG. 1, the chassis 2 can be mounted on wheels 12. The wheels 12 are preferably located at the rear of the chassis 2. Furthermore, each conveyor 50, 60, 70, 80 can rest on the ground via skids 13. Alternatively or additionally, each conveyor 50, 60, 70, 80 can rest on the ground via caster wheels. As shown, the machine 1 is preferably designed to be hitched to the rear of the tractor 8.

Preferably, when the machine 1 is switched from one mode to another, the conveyors 50, 60, 70, 80 are not moved relative to the chassis 2 in the conveying orientation C. In this way, when the machine 1 is switched from the work mode to the headland or transport mode, the conveyors 50, 60, 70, 80 are advantageously returned to the configuration in their last work mode. This avoids the need for the user to reset the conveying speed and direction C1, C2 of the conveyors 50, 60, 70, 80. Alternatively, when the machine 1 is switched to headland or transport mode, the monitoring device 7 could store in its or a storage device the last configuration for the conveyors 50, 60, 70, 80 in work mode, so that when the machine 1 is again switched to work mode, the monitoring device 7 automatically places the conveyors 50, 60, 70, 80 in this last configuration, thereby automatically setting the speeds and directions C1, C2 of the conveyors 50, 60, 70, 80 without the need for further user intervention.

Of course, the invention is not limited to the embodiments described and shown in the appended drawings and available in several constructive variants. Modifications remain possible, in particular as regards the composition of the various elements or the substitution by technical equivalents without departing from the scope of protection of the invention.

1. Agricultural haymaking machine intended to be moved in a direction of advance and comprising at least two conveyors, each conveyor being configured to move a product in a conveying orientation transverse to the direction of advance in a first conveying direction or a second conveying direction, and able to be driven at a respective speed, with at least one conveyor substantially movable in the conveying orientation, so that the conveyors can be placed in at least one lateral configuration, in which all the conveyors are adjacent, the conveying directions of all the conveyors are identical, and the product is deposited by an outfeed conveyor, with it also being possible to place the conveyors in a central configuration,
machine characterized in that, when the conveyors are placed in the or each lateral configuration, the speed of at least one conveyor is automatically set so that the speed of the outfeed conveyor is greater than that of the other conveyor(s).

2. Machine according to claim 1, characterized in that, when the conveyors are placed in the or each lateral configuration, the conveying direction of at least one of the conveyors is automatically set so that the conveying directions of all the conveyors are identical.

3. Machine according to claim 1, characterized in that in the central configuration, the conveyors closest to the midplane are separated from one another by a central spacing and the conveying directions of the conveyors are directed in the direction of the midplane, and in that when the conveyors are placed in the central configuration, at least the speeds of the conveyors closest to the midplane are set automatically to an identical value lower than the speed of the outfeed conveyor in lateral configuration.

4. Machine according to claim 1, characterized in that when the conveyors are placed in the central configuration, the conveying direction of at least one of the conveyors is automatically set so that the conveying direction of each of the conveyors is directed in the direction of the midplane.

5. Machine according to claim 2, characterized in that the machine comprises a monitoring device configured to automatically set the central spacing, as well as the conveying directions and speeds of the conveyors, based on their configuration.

6. Machine according to claim 2, characterized in that the machine comprises a monitoring device able to receive a signal representing the configuration of the conveyors and, based on this signal, to set the conveying direction and the speed of at least one conveyor.

7. Machine according to claim 6, characterized in that the signal representing the configuration of the conveyors comprises a signal representing the conveying direction of each conveyor and a signal representing the central spacing.

8. Machine according to claim 5, characterized in that the monitoring device is able to receive a signal representing the speed of advance of the machine and set the speed of at least one conveyor based on this speed of advance.

9. Machine according to claim 8, characterized in that the monitoring device can be configured to set the speed of each conveyor to a minimum value, when the speed of advance of the machine is below a given limit.

10. Machine according to claim 5, characterized in that a transfer device is associated with each conveyor, each transfer device being able to present a respective transfer speed, and in that the monitoring device can be configured to automatically set the speed of each transfer device based on the speed of the associated conveyor.

11. Machine according to claim 5, characterized in that, when the conveyors are placed in the or each lateral configuration, the monitoring device is configured to automatically set the speed of each conveyor, so that the closer the conveyor is to the outfeed conveyor, the greater its speed.

12. Machine according to claim 1, characterized in that the machine can occupy a work mode in which the conveyors extend substantially horizontally and/or parallel to the ground and at least one other mode, and in that when the machine is switched from one mode to another, the conveyors are not moved relative to the chassis in the conveying orientation.
